(19) United States
(12) Patent Application Publication
(10) Pub. No.: US 2022/0340003 A1
(43) Pub. Date: Oct. 27, 2022

(54) PROPELLER SHAFT

(71) Applicant: HITACHI ASTEMO, LTD., Hitachinaka-shi, Ibaraki (JP)

(72) Inventors: Hidekazu AOKI, Hitachinaka-shi, Ibaraki (JP); Kenichiro ISHIKURA, Hitachinaka-shi, Ibaraki (JP)

(73) Assignee: HITACHI ASTEMO, LTD., Hitachinaka-shi, Ibaraki (JP)

(21) Appl. No.: 17/641,353

(22) PCT Filed: Sep. 3, 2020
(86) PCT No.: PCT/JP2020/033451

§ 371 Date: Mar. 8, 2022

(30) Foreign Application Priority Data
Sep. 17, 2019 (JP) 2019-167926

(51) Int. Cl. B60K 17/22; F16D 3/84; F16D 3/223

(52) U.S. Cl. CPC B60K 17/22; F16D 3/84; F16D 3/223; F16D 2300/0212

(57) ABSTRACT

A propeller shaft includes an outer ring member having a bottom section through which a vent hole is formed, on a first end part connected to a shaft member. The propeller shaft further includes an inner ring member provided to the inner peripheral side of a second end part of the outer ring member on the side axially opposite to the first end part and connected to a rod member; a ball member between the inner and outer ring members, which is lubricated by grease; a plate member attached to the inner peripheral part of the outer ring member and forming an auxiliary chamber with the bottom section; and a communication path. The communication path allows communication between the first end part side and the second end part side of the outer ring member with the plate member interposed therebetween.

### TECHNICAL FIELD

The present invention relates to a propeller shaft.

### BACKGROUND TECHNOLOGY

As a conventional propeller shaft, for example, one which is described in the following patent document 1 has been known.

That is, this propeller shaft is one in which a first shaft connected to a transmission side is connected to a second shaft connected to a differential side via a constant velocity universal joint. The constant velocity universal joint includes an outer ring member connected to the first shaft, an inner ring member arranged inside the outer ring member and connected to the second shaft, and a plurality of ball members rollably held between the outer ring member and the inner ring member via a retainer. A cylindrical boot member for air-tightly protecting a bearing accommodating space formed inside the outer ring member is attached between the outer ring member and the second shaft, and the bearing accommodating space is filled with grease for the lubrication of the constant velocity universal joint. Here, a bottom section of the outer ring member is formed with a vent hole for communicating between the inside and the outside of the bearing accommodating space, and by the vent hole, it is possible to adjust the internal pressure of the bearing accommodating space which has increased due to the heating of the constant velocity universal joint.

### PRIOR ART DOCUMENT

### Patent Document

Patent Document 1: Japanese Patent Application Publication 2006-275195

### SUMMARY OF THE INVENTION

### Problem(s) to be Solved by the Invention

However, in the conventional propeller shaft, the bottom section of the outer ring member is formed with the vent hole so as to penetrate therethrough, and there is therefore possibility that the grease filled in the bearing accommodating space is discharged to the outside of the outer ring member through the vent hole.

Therefore, the present invention is developed in consideration of such a technical problem of the conventional propeller shaft, and an object of the present invention is to provide a propeller shaft which is capable of suppressing the grease filled inside the outer ring member from being discharged toward the outside of the constant velocity universal joint.

### Means for Solving the Problem(s)

The present invention, in one aspect thereof, includes: an outer ring member having a bottom section through which a vent hole is formed, on a first end part connected to a shaft member; an inner ring member provided to the inner peripheral side of a second end part of the outer ring member on the side axially opposite to the first end part and connected to a rod member; a ball member provided between the outer ring member and the inner ring member and lubricated by a grease; a partitioning plate attached to the inner peripheral part of the outer ring member and forming an auxiliary chamber with the bottom section; and a communication path which is either provided to the partitioning plate or formed by cooperation of the partitioning plate and the outer ring member to allow communication between the first end part side and the second end part side of the outer ring member with the partitioning plate interposed therebetween.

### Effect of the Invention

According to the present invention, it is possible to suppress the grease filled inside the outer ring member from being discharged toward the outside of the constant velocity universal joint.

### BRIEF DESCRIPTION OF THE DRAWINGS

FIG. 1 is an enlarged sectional view of a main part of a propeller shaft according to a first embodiment of the present invention.

FIG. 2 is a figure showing a variation of the first embodiment of the present invention, and FIG. 2 (a) is an enlarged sectional view in which an A part of FIG. 1 is enlarged and shown, and FIG. 2 (b) is an enlarged sectional view in which a B part of FIG. 1 is enlarged and shown.

FIG. 3 is an enlarged sectional view of a main part of the propeller shaft according to a second embodiment of the present invention.

FIG. 4 is an enlarged sectional view of a main part of the propeller shaft according to a third embodiment of the present invention.

FIG. 5 is an enlarged sectional view of a main part of the propeller shaft according to a fourth embodiment of the present invention.

FIG. 6 is an enlarged sectional view of a main part of the propeller shaft according to a fifth embodiment of the present invention.

FIG. 7 is an enlarged sectional view of a main part of the propeller shaft according to a sixth embodiment of the present invention.

FIG. 8 is a figure when viewing a press fitting protrusion shown in FIG. 7 from a first end part side of an outer ring member.

FIG. 9 is an enlarged sectional view of a main part of the propeller shaft according to a seventh embodiment of the present invention.

FIG. 10 is an enlarged sectional view of a main part of the propeller shaft according to an eighth embodiment of the present invention.

### MODE FOR IMPLEMENTING THE INVENTION

In the following, embodiments of a propeller shaft according to the present invention will be explained in detail based on the figures. In addition, in each of the following embodiments, as an example, similar to the conventional one, one applied to the propeller shaft for a vehicle will be explained.

### First Embodiment

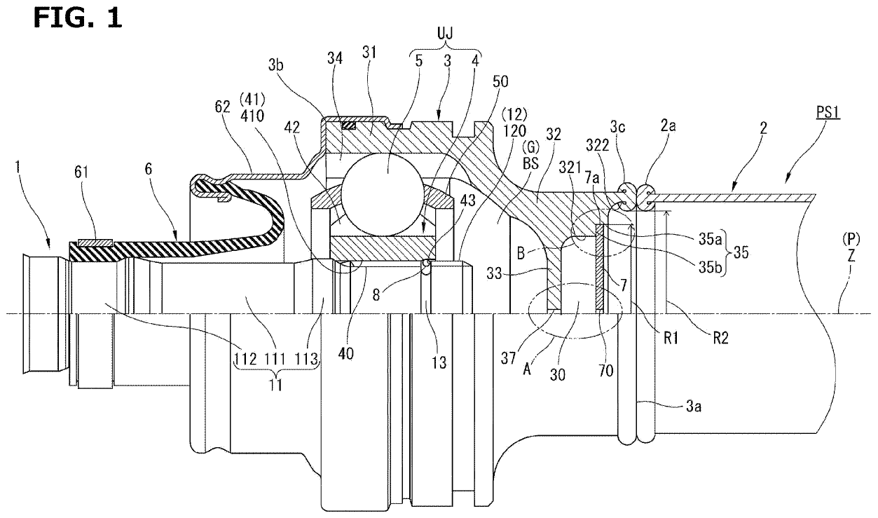

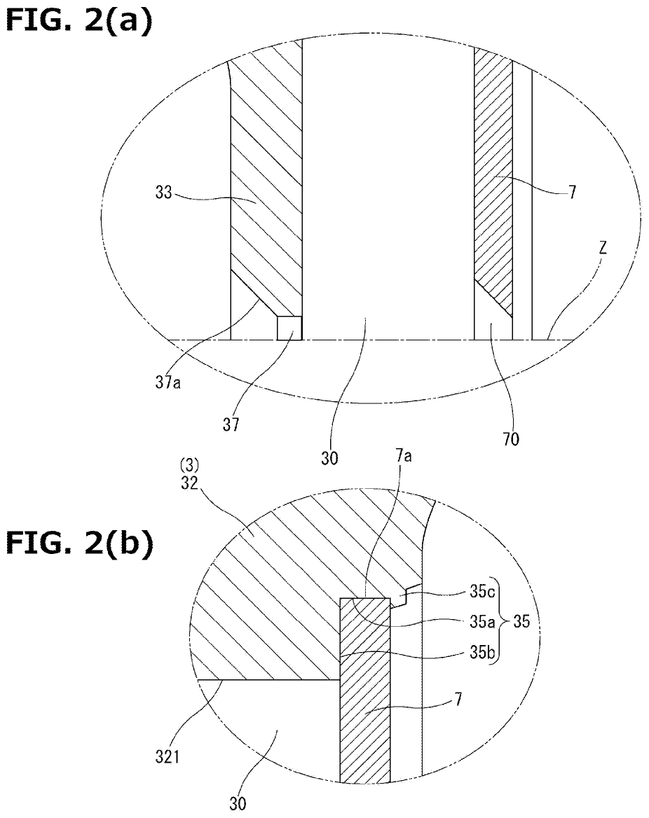

FIG. 1 shows an enlarged sectional view of a main part of a propeller shaft according to a first embodiment in the present invention. FIG. 2 shows an enlarged sectional view of a main part of the propeller shaft according to a variation of the first embodiment in the present invention. In addition, in the following explanation, for convenience, in each of FIG. 1 and FIG. 2, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

(Configuration of Propeller Shaft)

A propeller shaft PS1 is provided with a drive shaft 1 that is a first shaft connected to a transmission device (transmission) which is not shown, and a driven shaft 2 that is a second shaft connected to a differential device (differential) which is not shown. The drive shaft 1 and the driven shaft 2 are configured so as to rotate integrally with each other via a constant velocity universal joint UJ that is a joint mechanism. In addition, the drive shaft 1 and the driven shaft 2 are connected to each other so as to be relatively movable in the axial direction via a collapse mechanism having the after-mentioned spline structure provided to the constant velocity universal joint UJ.

The drive shaft 1 is one in which the rear end part thereof is configured by a stub shaft that is a rod member connected to an inner ring member 4 of the constant velocity universal joint UJ via the after-mentioned spline structure. In addition, the front end part of the drive shaft 1 is connected to the transmission device which is not shown via a universal joint which is not shown, so as to be integrally rotatable. Specifically, the first shaft 1 includes a drive shaft body part 11 which has a step shape whose outer diameter stepwisely increases and decreases and is connected to the universal joint which is not shown, and a male spline part 12 integrally provided to the rear end part of the drive shaft body part 11, and capable of being fitted to a female spline part 41 of the after-mentioned inner ring member 4.

The drive shaft body part 11 includes a drive shaft general section 111 formed to have a substantially fixed outer diameter, a boot fastening section 112 provided on the front end side of the drive shaft general section 111 to fasten one end part of the after-mentioned boot member 6, and an engaging projection section 113 provided to the rear end part of the drive shaft general section 111 and capable of engaging with the front end edge of the after-mentioned inner ring member 4.

The male spline part 12 is formed with, on the outer peripheral side thereof, a male spline tooth part 120 extending along the axial direction. In addition, on the outer peripheral side of the male spline part 12, a circlip fitting groove 13 that is an annular groove continued along the circumferential direction is formed. That is, a circlip 8 fitted to the circlip fitting groove 13 engages with a circlip engaging groove 43 of the after-mentioned inner ring member 4, and the drive shaft 1 is prevented from coming off from the inner ring member 4, so as to maintain a connection state with the inner ring member 4.

The driven shaft 2 is formed by a tube member that is a cylindrical shaft member in which the front end part of the drive shaft 2 is joined to the after-mentioned outer ring member 3 by so-called friction welding (friction stir welding). In addition, the rear end part of the driven shaft 2 is connected to the differential device which is not shown via a universal joint which is not shown, so as to be integrally rotatable. Moreover, a joint part that is the front end part of the driven shaft 2 and is joined to the outer ring member 3 is formed with a driven-shaft-side curled part 2a expanded on the inside and outside in the radial direction by the friction welding and annularly formed along the circumferential direction. In addition, in the present embodiment, although the outer ring member 3 is joined to the driven shaft 2 by friction welding as an example, another joining means may be used to join them to each other.

The constant velocity universal joint UJ is provided with an outer ring member 3 having a rear end part (first end part 3a) connected to the driven shaft 2, an inner ring member 4 arranged on the inner peripheral side of the outer ring member 3 and input with drive torque from the drive shaft 1, and a plurality of ball members 5 that are rolling elements rollably held by a retainer 50 arranged between the outer ring member 3 and the inner ring member 4. In addition, the inside of a bearing accommodating space BS formed on the inner peripheral side of the outer ring member 3 is filled with a grease G for lubricating the constant velocity universal joint UJ. Moreover, a boot member 6 having a substantially cylindrical shape is provided between the drive shaft 1 and the outer ring member 3 so as to extend between the drive shaft 1 and the outer ring member 3. That is, by covering the connection part (constant velocity universal joint UJ) between the drive shaft 1 and the driven shaft 2 with the boot member 6, the inside of the bearing accommodating space BS is protected in an airtight state, and thereby an excellent lubricant state of the constant velocity universal joint UJ is maintained.

The outer ring member 3 includes a bearing constituting section 31 provided on a front end side (second end part 3b side) and composing the constant velocity universal joint UJ, and a connection base section 32 provided on a rear end side (first end part 3a side) and connected to the driven shaft 2. The bearing constituting section 31 is formed integrally with the connection base section 32 by the forging of an iron material.

The front end side of the bearing constituting section 31 is opened, and the rear end side thereof is closed by a bottom section 33 such that the bearing constituting section 31 is formed in a substantially cup shape. In addition, on the inner peripheral side of the bearing constituting section 31, outer-ring-side raceway grooves 34 extending in straight lines along the axial direction are formed at substantially equal intervals in the circumferential direction. The outer-ring-side raceway grooves 34 cooperate with the after-mentioned inner-ring-side raceway grooves 42 to allow the movement in the axial direction of the ball members 5, and to limit the movement in the circumferential direction of the ball members 5.

That is, in the bearing constituting section 31, the ball members 5 move in the axial direction along raceway grooves formed between the outer-ring-side grooves 34 and the after-mentioned inner-ring-side raceway grooves 42, thereby allowing the relative movement of the outer ring member 3 and the inner ring member 4 in the axial direction. On the other hand, in the bearing constituting section 31, in the circumferential direction, the ball members 5 engage with the raceway grooves formed between the outer-ring-side raceway grooves 34 and the after-mentioned inner-ring-side raceway grooves 42, and the relative movement of the outer ring member 3 and the inner ring member 4 in the circumferential direction, namely, relative rotation is limited, and the outer ring member 3 rotates integrally with the inner ring member 4 based on the drive torque input from the inner ring member 4 side.

The rear end side of the connection base section 32 is opened, and the front end side thereof is closed by the bottom section 33 such that the connection base section 32 is formed in a cylindrical shape having a bottom. In addition, the connection base section 32 is formed so as to have different thickness in the axial direction such that the inner diameter is stepwisely enlarged toward the rear end side. That is, the connection base section 32 includes a small diameter section 321 provided on the front end side and arranged adjacent to the bottom section 33, and a large diameter section 322 provided on the rear end side and set to have an inner diameter larger than that of the small diameter section 321. In addition, an annular groove part 35 set to have an inner diameter larger than that of the small diameter section 321 and smaller than that of the large diameter section 322 is formed between the small diameter section 321 and the large diameter section 322. The groove part 35 is formed by machining, between the small diameter section 321 and the large diameter section 322 formed by the above-mentioned forging.

The bottom section 33 of the outer ring member 3 is formed with a vent hole 37 having a fixed minute inner diameter by penetrating therethrough in the axial direction so as to communicate the bearing accommodating space BS defined on the inner peripheral side of the bearing constituting section 31 and the after-mentioned auxiliary chamber 30 defined on the inner peripheral side of the connection base section 32, and the vent hole 37 is formed at a position superposed on (overlapping) the rotation axial line Z of the propeller shaft PS1. The vent hole 37 penetrates in the axial direction with a fixed minute inner diameter, so as to adjust the inner pressure of the bearing accommodating space BS sealed with the boot member 6 by releasing, to the after-mentioned auxiliary chamber 30, the inner pressure of the bearing accommodating space BS which has increased due to the heating of the constant velocity universal joint UJ.

Here, the vent hole 37 is not limited to one having a fixed inner diameter, and, for example, as shown in FIG. 2 (a), it may be formed in a conical taper shape in which the inner diameter thereof gradually increases from the rear end part (first end part 3a) side toward the front end part (second end part 3b) side of the outer ring member 3. Moreover, in case where the vent hole 37 is formed in a conical taper shape, the entire vent hole 37 may be formed in the conical taper shape, or, as shown in FIG. 2 (a), part in the axial direction range of the vent hole 37 may be formed as a conical taper part 37a having the taper shape. In addition, although it is desirable that the vent hole 37 is arranged at the middle position of the bottom section 33 of the outer ring member 3, namely, at the position corresponding to the rotation center of the propeller shaft PS1, the arrangement is not limited to this, and it can be arbitrarily changed.

The groove part 35 of the connection base section 32 is provided with a plate member 7 which covers the rear-end-side opening part of the small diameter section 321 so as to serve as a partitioning plate forming the auxiliary chamber 30 between the bottom section 33 and the plate member 7. The plate member 7 is a metal disc plate having a substantially uniform thickness, has an outer diameter slightly larger than the inner diameter of the groove part 35, has an outer peripheral surface 7a press-fitted to an inner peripheral surface 35a of the groove part 35, and is attached in a state of coming in contact with a step part 35b formed between the groove part 35 and the small diameter section 321.

Here, the attachment means (fixing means) of the plate member 7 is not limited to the above-mentioned press-fitting. That is, in addition to the press-fitting, for example, as shown in FIG. 2 (b), the engagement and fixing of the plate member 7 can also be carried out by a caulking portion 35c formed by crushing part of the opening end edge of the groove part 35 in a state in which the plate member 7 is inserted into the groove part 35. In addition, it is desirable to provide a plurality of caulking portions 35c at substantially equal intervals in the circumference direction of the groove part 35, and the plate member 7 can be fixed more firmly as the number of the caulking portions 35c increases.

In addition, at the substantially middle position of the plate member 7, namely, at the rotation center position of the propeller shaft PS1 which overlaps the rotation axial line Z, a hole 70 as a communication path communicating an inner-peripheral-side space 20 of the driven shaft 2 and the auxiliary chamber 30 is formed so as to penetrate along the axial direction. In other words, by the hole 70, a communication path for communicating the inner-peripheral-side space 20 of the driven shaft 2 and the auxiliary chamber 30 is formed at the rotation center position of the propeller shaft PS1. The hole 70 penetrates along the axial direction while keeping a fixed minute inner diameter that is substantially the same diameter as that of the vent hole 37, such that the inner pressure (expanded air) of the bearing accommodating space BS which has escaped to the auxiliary chamber 30 can be discharged to the inner-peripheral-side space 20 of the driven shaft 2.

Here, the hole 70 is not limited to one having a fixed inner diameter, and, for example, as shown in FIG. 2 (a), it may be formed in a conical taper shape in which the inner diameter thereof gradually increases from the rear end part (first end part 3a) side toward the front end part (second end part 3b) side of the outer ring member 3. Moreover, in case where the hole 70 is formed in a conical taper shape, the entire hole 70 may be formed in the conical taper shape as shown in FIG. 2 (a), or part in the axial direction range of the hole 70 may be formed in the conical taper shape. In addition, although it is desirable that the hole 70 is arranged at the middle position of the plate member 7, namely, at the position corresponding to the rotation center of the propeller shaft PS1, the arrangement is not limited to this, and it can be arbitrarily changed.

In addition, at the rear end part (first end part 3a) of the outer ring member 3 which faces the driven shaft 2, namely, at the joint part joined to the drive shaft 2 that is the rear end part of the large diameter section 322, an outer-ring-member-side curled part 3c expanded to the inner side and the outer side in the radial direction is annularly formed along the circumferential direction by the above-mentioned friction welding. In addition, an inner diameter R1 of the groove part 35 of the outer ring member 3 is set smaller than an inner diameter R2 of the outer-ring-member-side curled part 3c.

The inner ring member 4 has a cylindrical shape, and is formed with, on the inner peripheral side thereof, a shaft insertion hole 40 through which the drive shaft 1 is inserted, by penetrating therethrough, and the shaft insertion hole 40 is formed with, on the inner peripheral side hereof, a female spline part 41 to which the male spline part 12 of the drive shaft 1 is fitted. The female spline part 41 is formed with a female spline tooth part 410 meshing with the male spline tooth part 120 of the drive shaft 1, along the axial direction. In addition, the inner ring member 4 is formed with, on the outer peripheral side thereof, inner-ring-side raceway grooves 42 that are axial grooves similar to the outer-ring-side raceway grooves 34 by penetrating therethrough in straight lines along the axial direction.

Moreover, the female spline tooth part 410 is formed with an annular circlip engagement groove 43 along the circumferential direction so as to engage with the circlip 8 attached to the drive shaft 1 (male spline part 12), at a position radially facing the circlip fitting groove 13 in a state in which the drive shaft 1 is inserted into the inner ring member 4. That is, when the male spline tooth part 120 of the drive shaft 1 is fitted to the female spline tooth part 410 of the inner ring member 4, the circlip 8 attached to the circlip engagement groove 13 in a contracted state is elastically returned, and then engages with the circlip engagement groove 43, thereby suppressing the drive shaft 1 from coming off from the inner ring member 4.

The boot member 6 is attached so as to cross between the first shaft 1 and the driven shaft 2, specifically, between the drive shaft 1 and the outer ring member 3, and the middle part of the boot member 6 is formed in a folded shape so as to be extendable in the axial direction. In addition, the front end part of the boot member 6 is fastened to the outer periphery of the boot fastening part 112 of the drive shaft 1 via a well-known boot band 61, and the rear end part of the boot member 6 is fixed to the outer periphery of the front end part (second end part 3b) of the outer ring member 3 via an attaching fitting 62 by caulking.

(Working Effect of Present Embodiment)

As mentioned above, in the conventional propeller shaft, the vent hole is formed to the bottom section of the outer ring member by penetrating therethrough. There is therefore a possibility that the grease filled in the bearing accommodating space is discharged to the outside of the outer ring member through the vent hole.

In contrast to this, in the propeller shaft PS1 according to the present embodiment, following effects can be obtained, and thereby the problem in the conventional propeller shaft can be solved.

The propeller shaft PS1 includes: a cylindrical shaft member (driven shaft 2); a cylindrical outer ring member 3 having a first end part 3a connected to the shaft member (driven shaft 2), and including, in order from a second end part 3b on an opposite side of the first end part 3a in a direction of a rotation axial line Z of the shaft member (driven shaft 2), a raceway groove (outer-ring-side raceway groove 34) provided on an inner peripheral surface of the outer ring member 3 and formed along the rotation axial line Z, a bottom section 33 extending from an inner peripheral part of the outer ring member 3 toward a rotation center of the shaft member (driven shaft 2), and a vent hole 37 provided to the bottom section 33; a ball member 5 which moves along the raceway groove (outer-ring-side raceway groove 34); an inner ring member 4 wherein the ball member 5 is arranged on an outer periphery of the inner ring member 4; a rod member (drive shaft 1) connected to the inner ring member 4, and extending from the first end part 3a toward the second end part 3b of the outer ring member 3 in the direction of the rotation axial line Z; a boot member 6 which covers between the second end part 3b of the outer ring member 3 and the rod member (first shaft 1); a grease G provided between the outer ring member 3 and the inner ring member 4; a partitioning plate (plate member 7) attached to the inner peripheral part of the outer ring member 3 so as to form an auxiliary chamber 30 between the bottom section 30 and the partitioning plate; and a communication path (hole 70) which is either provided to the partitioning plate (plate member 7) or formed by cooperation of the partitioning plate (plate member 7) and the outer ring member 3 to allow communication between a first end part 3a side and a second end part 3b side of the outer ring member 3 with the partitioning plate (plate member 7) interposed therebetween.

In this way, in the present embodiment, the auxiliary chamber 30 is formed between the bottom section 33 of the outer ring member 3 and the plate member 7. Therefore, even in case where the grease G leaks from the inside of the outer ring member 3 through the vent hole 37 due to the relative movement in the axial direction of the drive shaft 1 and the driven shaft 2, the grease G leaking out from the vent hole 37 can be held in the auxiliary chamber 30. Consequently, it is possible to suppress the occurrence of a failure that the grease G leaks to the outside of the outer ring member 3.

In addition, in the present embodiment, by the vent hole 37 and the communication path (hole 70), thermally expanded air which remains in the inner peripheral side (bearing accommodating space BS) of the outer ring member 3 can be released to the inner peripheral side of the driven shaft 2 through the communication path (hole 70), and thereby the constant velocity universal joint UJ is appropriately operated.

Moreover, in the present embodiment, the inner peripheral side (bearing accommodating space BS) of the outer ring member 3 is communicated with the inner peripheral side of the driven shaft 2 via the vent hole 37 and the communication path (hole 70). Therefore, the inner peripheral side (bearing accommodating space BS) of the outer ring member 3 is not opened to the atmosphere, and there is no possibility that foreign substances such as muddy water enter into the inner peripheral side (bearing accommodating space BS) of the outer ring member 3 from the outside.

In addition, in the present embodiment, the communication path is formed by the hole 70 penetrating through the partitioning plate (plate member 7).

In this way, since the communication path is formed by the hole 70 penetrating through the plate member 7, the communication path can be formed with a simpler structure. Consequently, the productivity of the propeller shaft PS1 is improved, and manufacturing cost can be reduced.

In addition, in the present embodiment, the partitioning plate (plate member 7) is provided between the first end part 3a and the bottom section 33 of the outer ring member 3, in the direction of the rotation axial line Z.

In this way, by arranging the plate member 7 between the first end part 3a and the bottom section 33 of the outer ring member 3, as compared with case where the plate member 7 is arranged between the second end part 3b and the bottom section 33 of the outer ring member 3, the bearing constituting section 31 of the outer ring member 3 can be relatively shallowly formed. With this, there is a merit that the forging of the outer ring member 3 can be relatively easily carried out.

In addition, in the present embodiment, the hole 70 is provided on the rotation center, in the direction of the rotation axial line Z.

The grease G which has entered into the auxiliary chamber 30 is pushed to the peripheral wall of the auxiliary chamber 30 with the rotation of the propeller shaft PS1. Therefore, as shown in the present embodiment, the hole 70 is provided on the rotation center and the hole 70 is positioned in the middle part of the plate member 7, and thereby it is possible to reduce a possibility that the grease G inside the auxiliary chamber 30 leaks toward the driven shaft 2 side through the hole 70. With this, it is possible to suppress the leakage of the grease G filled in the inside of the outer ring member 3 to the outside (leakage toward the driven shaft 2 side).

In addition, in the present embodiment, the vent hole 37 is provided on the rotation center, in the direction of the rotation axial line Z.

The grease G inside the bearing accommodating space BS is pushed to the peripheral wall of the bearing accommodating space BS with the rotation of the propeller shaft PS1. Therefore, as shown in the present embodiment, the vent hole 37 is provided on the rotation center and the vent hole 37 is positioned in the middle part of the bottom section 33, and thereby it is possible to reduce a possibility that the grease G inside the bearing accommodating space BS leaks toward the auxiliary chamber 30 side through the vent hole 37. With this, it is possible to suppress the leakage of the grease G filled in the inside of the outer ring member 3 to the outside (leakage toward the driven shaft 2 side).

In addition, in the present embodiment, the partitioning plate (plate member 7) is press-fitted into the groove part 35 provided to the inner peripheral part of the outer ring member 3.

In this way, the plate member 7 is press-fitted into the groove part 35 of the outer ring member 3 such that the plate member 7 is fixed to the outer ring member 3, and thereby an unnecessary attaching means is not required. Consequently, the weight and the manufacturing cost of the propeller shaft PS1 can be reduced.

In addition, it is desirable that the partitioning plate (plate member 7) is fixed to the groove part 35 provided to the inner peripheral part of the outer ring member 3 by caulking.

As compared with the press-fitting, by the caulking, the plate member 7 can be fixed more firmly. Consequently, it is possible to suppress the occurrence of coming-off of the plate member 7 due to, for example, vibrations transmitted from, for example, the vehicle body side, and thereby the durability of the propeller shaft PS1 can be enhanced.

In addition, it is desirable that at least one of the inner diameters of the hole 70 and the vent hole 37 gradually increases from the first end part 3a side toward the second end part 3b side of the outer ring member 3 in the direction of the rotation axial line Z.

The grease G which has entered into the hole 70 and the vent hole 37 is pushed to the peripheral walls of the hole 70 and the vent hole 37 by centrifugal force with the rotation of the propeller shaft PS1. Therefore, each of the hole 70 and the vent hole 37 is gradually enlarged from the first end part 3a side toward the second end part 3b side of the outer ring member 3, and, consequently, the grease G which has entered into the insides of the hole 70 and the vent hole 37 can be moved toward the second end part 3b side along the peripheral walls of the hole 70 and the vent hole 37. With this, it is possible to more effectively suppress the leakage of the grease G inside the auxiliary chamber 30 or the bearing accommodating space BS to the outside.

### Second Embodiment

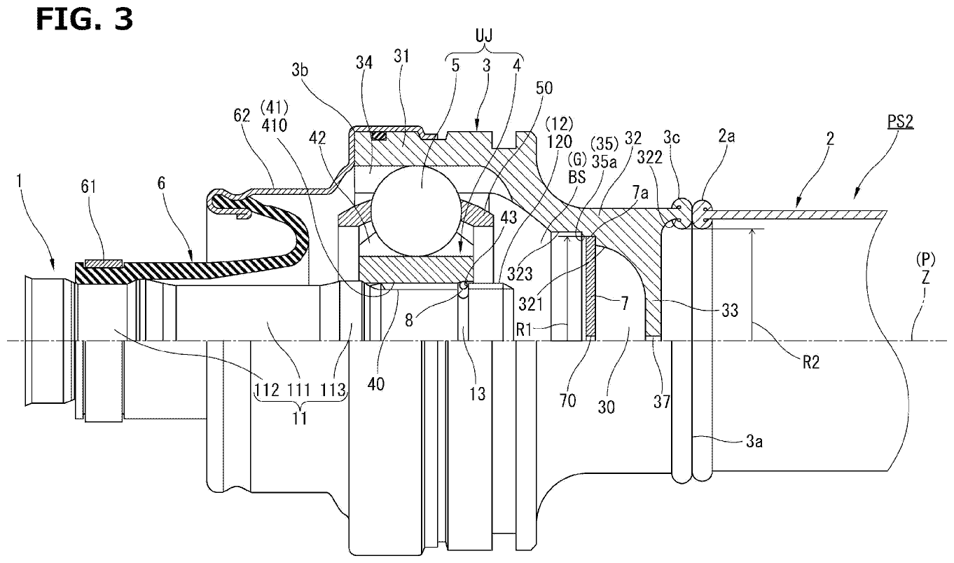

FIG. 3 shows a second embodiment of the propeller shaft according to the present invention, and in the second embodiment, the arrangement of the plate member 7 according to the first embodiment is changed. In addition, since a basic configuration of the second embodiment except the changed part is the same as that of the first embodiment, the same symbols are applied to the same components of the first embodiment, and redundant explanation is omitted.

FIG. 3 shows an enlarged sectional view of a main part of the propeller shaft according to the second embodiment of the present invention. In addition, in the following explanation, for convenience, in FIG. 3, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS2 according to the present embodiment, the small diameter section 321 and the groove part 35 of the connection base section 32 according to the first embodiment are provided more on the front side than the bottom section 33 in the axial direction. Specifically, the connection base section 32 of the outer ring member 3 includes, in order from the rear end part (first end part 3a of the outer ring member 3), a large diameter section 322, a bottom section 33 having a vent hole 37 in the middle part thereof, a small diameter section 321 having an inner diameter smaller than that of the large diameter section 322, an intermediate diameter section 323 having an inner diameter larger than that of the small diameter section 321 and smaller than that of the large diameter section 322. Moreover, an annular groove part 35 having an inner diameter larger than that of the small diameter section 321 and smaller than that of the intermediate diameter section 323 is formed between the small diameter section 321 and the intermediate diameter section 323 along the circumferential direction. In addition, the groove part 35 is formed by machining, and arranged between the small diameter section 321 and the intermediate diameter section 323 formed by the above-mentioned forging.

Then, similar to the first embodiment, a disk-shaped plate member 7 including, in the middle part thereof, a hole 70 is press-fitted into the groove part 35. In addition, by the plate member 7, the front-end-side opening of the small diameter section 321 is closed, and an auxiliary chamber 30 is provided between the bottom section 33 of the outer ring member 3 and the plate member 7.

As the above, according to the present embodiment, the partitioning plate (plate member 7) is provided between the second end part 3b and the bottom section 33 of the outer ring member 3, in the direction of the rotation axial line Z.

Since the outer ring member 3 is formed by the above-mentioned forging, due to manufacturing errors with the forging, in order to secure an appropriate operation of the collapse mechanism, namely, a relative moving distance required for the drive shaft 1 with respect to the driven shaft 2, it is necessary to provide a fixed margin on the distance of the bottom section 33 and the bearing accommodating space BS. In contrast to this, by arranging the plate member 7 between the front end part (second end part 3b) and the bottom section 33 of the outer ring member 3 as shown in the present embodiment, the axial position of the plate member 7 which is press-fitted into and fixed to the groove part 35 which can be formed with high accuracy as compared with when being formed by forging can be positioned closer to the bearing accommodating space BS. Consequently, the shortening in the axial direction and a reduction in the size of the ring member 3 can be achieved.

### Third Embodiment

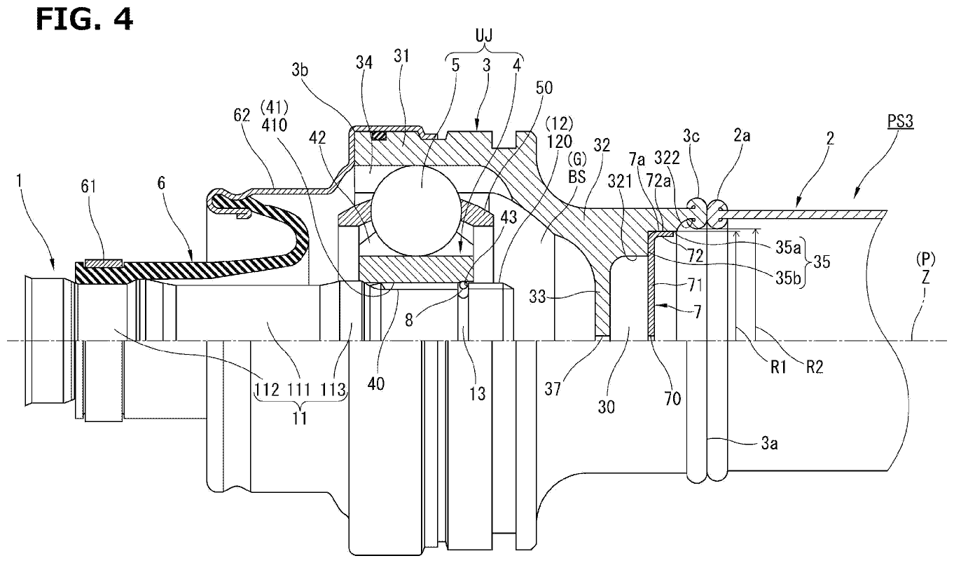

FIG. 4 shows a third embodiment of the propeller shaft according to the present invention, and in the third embodiment, the shape of the plate member 7 according to the first embodiment is changed. In addition, since a basic configuration of the third embodiment except the changed part is the same as that of the first embodiment, the same symbols are applied to the same components of the first embodiment, and redundant explanation is omitted.

FIG. 4 shows an enlarged sectional view of a main part of the propeller shaft according to the third embodiment of the present invention. In addition, in the following explanation, for convenience, in FIG. 4, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS3 according to the present embodiment, the outer peripheral edge portion of the plate member 7 according to the first embodiment is bent so as to extend from the second end part 3b side toward the first end part 3a side of the outer ring member 3. Specifically, the plate member 7 according to the present embodiment is made of a metal material and is formed such that a plate bottom portion 71 which closes the rear-end-side opening portion of the small diameter section 321 is formed integrally with a plate press fitting portion 72 protruding from the outer peripheral edge portion of the plate bottom portion 71 and used when the plate member 7 is press-fitted. Then, the plate press fitting portion 72 is press-fitted into the groove part 35, and the plate member 7 is fixed to the outer ring member 3. The plate bottom portion 71 extends along the radial direction so as to be formed substantially parallel to the bottom section 33, and is formed with, in the middle part thereof, a hole 70 by penetrating therethrough. The plate press fitting portion 72 is connected to the outer peripheral edge portion of the plate bottom portion 71, and extends from the second end part 3b side toward the first end part 3a side of the outer ring member 3, and an outer peripheral surface 72a of the plate press fitting portion 72 is press-fitted to an inner peripheral surface 35a of the groove part 35.

As mentioned above, according to the present embodiment, the partitioning plate (plate member 7) includes the partitioning plate bottom portion (plate bottom portion 71) extending toward the rotation center and formed with the hole 70, and the partitioning plate press fitting portion (plate press fitting portion 72) capable of being press-fitted into the groove part 35 which extends from the outer peripheral edge portion of the partitioning plate bottom portion (plate bottom portion 71) along the direction of the rotation axial line Z, and is press-fitted into the groove part 35 from the partitioning plate bottom portion (plate bottom portion 71) side.

In this way, in the present embodiment, the plate member 7 is press-fitted into the groove part 35 via the plate press fitting portion 72 formed by bending the outer peripheral side (outer peripheral edge portion) of the plate member 7 in the axial direction. With this, as compared with the first embodiment having a configuration in which the thin disc-shaped outer peripheral surface of the plate member 7 is formed as “plate press fitting portion”, the press-fitting margin of the plate press fitting portion 72 can be sufficiently secured, and the press-fitting strength of the plate member 7 can be further increased. Consequently, the holding performance of the plate member 7 in the groove part 35 of the outer ring member 3 is improved, and the durability of the propeller shaft PS3 can be improved.

### Fourth Embodiment

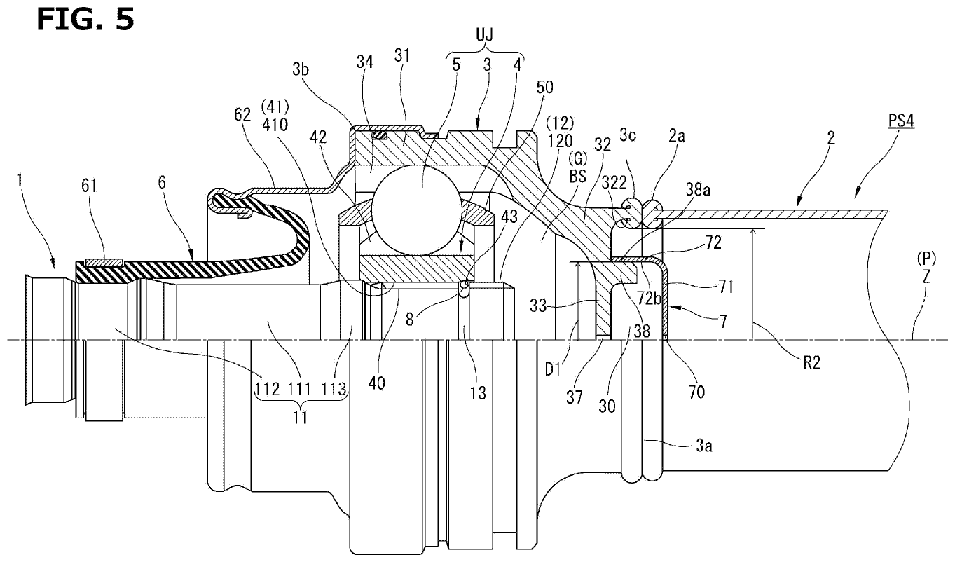

FIG. 5 shows a fourth embodiment of the propeller shaft according to the present invention, and in the fourth embodiment, the shape of the plate member 7 according to the first embodiment is changed. In addition, since a basic configuration of the fourth embodiment except the changed part is the same as that of the first embodiment, the same symbols are applied to the same components of the first embodiment, and redundant explanation is omitted.

FIG. 5 shows an enlarged sectional view of a main part of the propeller shaft according to the fourth embodiment of the present invention. In addition, in the following explanation, for convenience, in FIG. 5, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS4 according to the present embodiment, the bottom section 33 of the outer ring member 3 is provided with a substantially cylindrical press fitting protrusion 38 protruding from the second end part 3b side toward the first end part 3a side of the outer ring member 3 in the axial direction. The press fitting protrusion 38 has an outer diameter D1 smaller than the inner diameter R2 of the outer-ring-member-side curled part 3c, and is provided so as to overlap the outer-ring-member-side curled part 3c in the axial direction.

The plate member 7 is made of a metal material and is formed such that a plate bottom portion 71 which closes the opening portion of the press fitting protrusion 38 is formed integrally with a plate press fitting portion 72 protruding from the outer peripheral edge portion of the plate bottom portion 71 and used when the plate member 7 is press-fitted. Then, the plate press fitting portion 72 is press-fitted to the outer peripheral side of the press fitting protrusion 38, and the plate member 7 is fixed to the outer ring member 3. The plate bottom portion 71 extends along the radial direction so as to be formed substantially parallel to the bottom section 33, and is formed with, in the middle part thereof, a hole 70 by penetrating therethrough. The plate press fitting portion 72 is connected to the outer peripheral edge portion of the plate bottom portion 71, and extends from the first end part 3a side toward the second end part 3b side of the outer ring member 3, and an inner peripheral surface 72b of the plate press fitting portion 72 is press-fitted to an outer peripheral surface 38a of the press fitting protrusion 38. With this, the auxiliary chamber 30 is defined by the bottom section 33 and the press fitting protrusion 38 of the outer ring member 3 and the plate bottom portion 71 of the plate member 7.

As mentioned above, according to the present embodiment, the outer ring member 3 includes the press fitting protrusion 38 protruding from the bottom section 33 so as to extend from the second end part 3b side toward the first end part 3a side of the outer ring member 3 in the direction of the rotation axial line Z, the first end part 3a of the outer ring member 3 is joined to the shaft member (driven shaft 2) by friction welding, the outer diameter D1 of the press fitting protrusion 38 is smaller than the inner diameter R2 of the joint part (driven-shaft-side curled part 2a) between the first end part 3a of the outer ring member 3 and the shaft member (driven shaft 2), and the partitioning plate (plate member 7) includes the partitioning plate press fitting portion (plate press fitting portion 72) capable of being press-fitted to the outer peripheral portion of the press fitting protrusion 38.

In this way, in the present embodiment, the plate member 7 is press-fitted to the outer peripheral side of the press fitting protrusion 38 having the outer diameter D1 smaller than the inner diameter R2 of the outer-ring-member-side curled part 3c and the driven-shaft-side curled part 2a. With this configuration, the auxiliary chamber 30 can be provided in the region overlapping the driven shaft in the axial direction, and thereby the distance (length) from a center P of the constant velocity universal joint UJ to the joint part between the outer ring member 3 and the driven shaft 2 can be shortened. As a result of this, it becomes possible to reduce the weight of the propeller shaft PS4 and the manufacturing cost of the propeller shaft PS4 based on a reduction in the material (metal material) used for the outer ring member.

Moreover, in the present embodiment, the partitioning plate (plate member 7) includes the partitioning plate bottom portion (plate bottom portion 71) formed with the hole 70, partitioning plate bottom portion which is connected to the partitioning plate press fitting portion (plate press fitting portion 72) and extends toward the rotation center.

In this way, in the present embodiment, the plate bottom portion 71 extends in the radial direction, and thereby it is possible to suppress the plate member 7 from coming in contact with the outer-ring-member-side curled part 3c and the driven-shaft-side curled part 2a. That is, there is no fear of the interference of the plate member 7 with the outer-ring-member-side curled part 3c and the driven-shaft-side curled part 2a, and thereby a stable joined state of the constant velocity universal joint UJ (outer ring member 3) and the driven shaft 2 can be secured.

### Fifth Embodiment

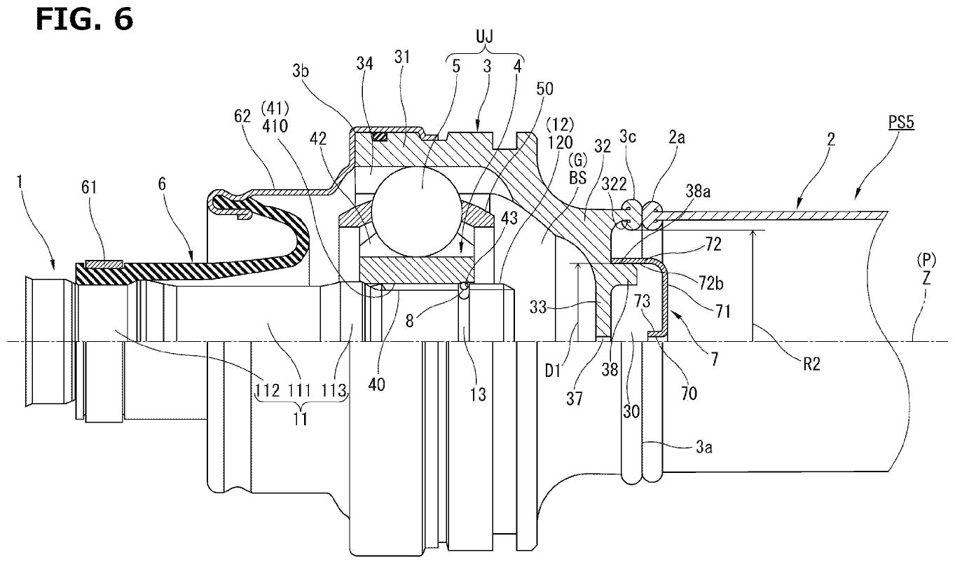

FIG. 6 shows a fifth embodiment of the propeller shaft according to the present invention, and in the fifth embodiment, the shape of the plate member 7 according to the fourth embodiment is changed. In addition, since a basic configuration of the fifth embodiment except the changed part is the same as that of the fourth embodiment, the same symbols are applied to the same components of the fourth embodiment, and redundant explanation is omitted.

FIG. 6 shows an enlarged sectional view of a main part of the propeller shaft according to the fifth embodiment of the present invention. In addition, in the following explanation, for convenience, in FIG. 6, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS5 according to the present embodiment, a plate protruding portion 73 that is a partitioning plate protruding portion protruding from the first end part 3a side toward the second end part 3b side of the outer ring member 3 in the axial direction is provided at the hole edge portion of the hole 70 that is the inner side surface of the plate bottom portion 71 of the plate member 7 (surface facing the bottom section 33 of the outer ring member 3). In other words, the plate protruding portion 73 extending toward the bottom section 33 of the outer ring member 3, namely, toward the auxiliary chamber 30 side in the axial direction is formed on the outer peripheral side of the hole 70 of the plate bottom portion 71 facing the bottom section 33 of the outer ring member 3, so as to protrude. The plate protruding portion 73 has a cylindrical shape, and is formed integrally with the plate bottom portion 71, and the hole 70 is penetratingly formed on the inner peripheral side thereof.

As mentioned above, according to the present embodiment, in the direction of the rotation axial line Z, the hole 70 is provided with the partitioning plate protruding portion (plate protruding portion 73) protruding from the first end part 3a side toward the second end part 3b side of the outer ring member 3.

As mentioned above, since the grease G inside the auxiliary chamber 30 is pushed to the peripheral wall of the auxiliary chamber 30 by centrifugal force with the rotation of the propeller shaft PS5, the grease G hardly leaks to the outside (inner peripheral side of the driven shaft 2) through the hole 70. In addition to this configuration, by further providing the plate protruding portion 73 protruding toward the auxiliary chamber 30 side at the peripheral edge portion of the hole 70, the grease G inside the auxiliary chamber 30 further hardly enters into the hole 70, and thereby it is possible to more effectively suppress the leakage of the grease G inside the auxiliary chamber 30 to the outside through the hole 70.

### Sixth Embodiment

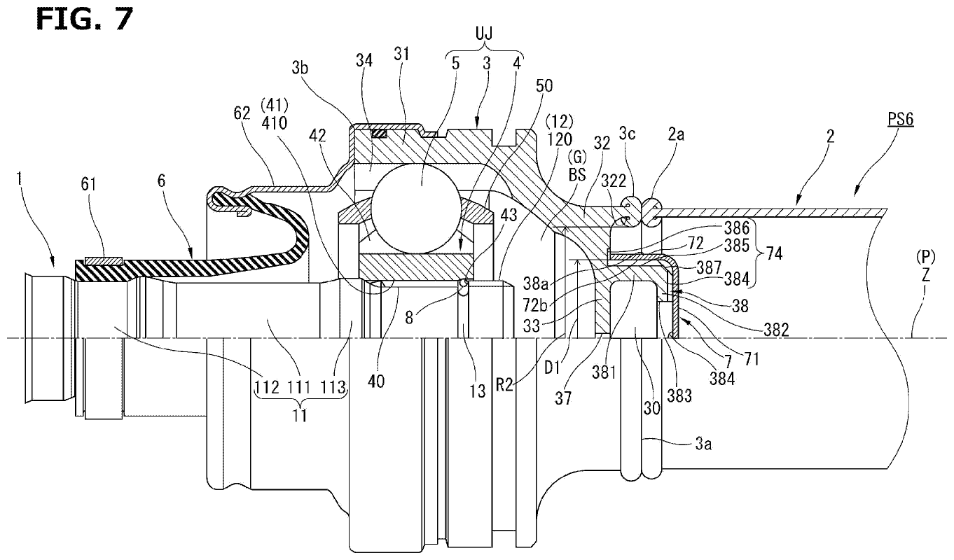

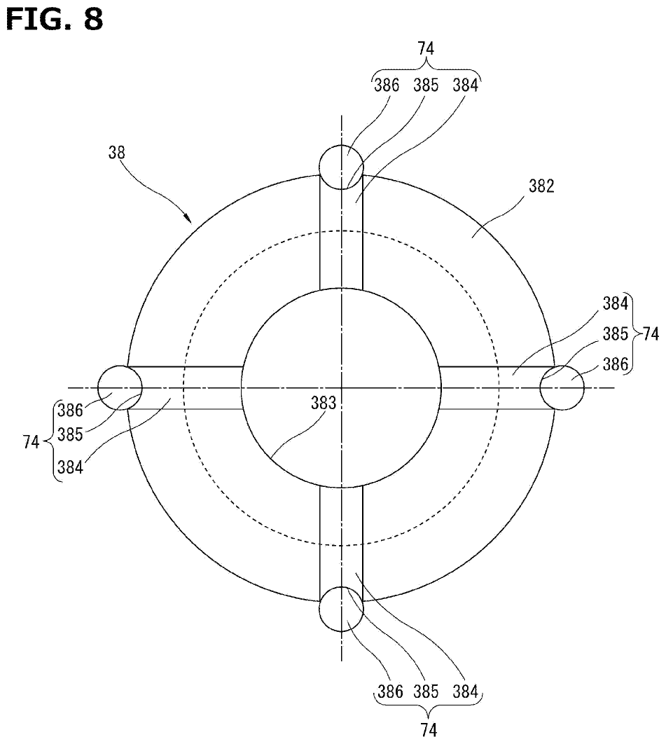

FIG. 7 and FIG. 8 each show a sixth embodiment of the propeller shaft according to the present invention, and in the sixth embodiment, the shape of the plate member 7 according to the fourth embodiment is changed. In addition, since a basic configuration of the sixth embodiment except the changed part is the same as that of the fourth embodiment, the same symbols are applied to the same components of the fourth embodiment, and redundant explanation is omitted.

FIG. 7 shows an enlarged sectional view of a main part of the propeller shaft according to the sixth embodiment of the present invention. FIG. 8 is a figure when viewing a press fitting protrusion 38 shown in FIG. 7 from the first end part 3a side. In addition, in the following explanation, for convenience, in each of FIG. 7 and FIG. 8, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS6 according to the present embodiment, the hole 70 according to the fourth embodiment is not provided, and, instead of the hole 70, by serial communication paths 74 each having a labyrinth shape which are formed between the plate member 7 and the press fitting protrusion 38, the discharging of the grease G inside the auxiliary chamber 30 to the outside is suppressed.

Specifically, in the present embodiment, the press fitting protrusion 38 of the outer ring member 3 includes an axially extending portion 381 extending from the bottom section 33 of the outer ring member 3 along the axial direction, a radially extending portion 382 extending from the rear end part of the axially extending portion 381 toward the inner side in the radial direction, and a through hole 383 provided in the middle part of the radially extending portion 382.

A plurality of radial vent grooves 384 (in the present embodiment, four radial vent grooves) communicated to the through hole 383 and extending along the radial direction are provided on the outer surface of the radially extending portion 382 at equal intervals (intervals of 90°) in the circumferential direction (see FIG. 8). Similarly, a plurality of axial vent grooves 385 (in the present embodiment, four axial vent grooves) communicated to the respective radial vent grooves 384 and extending along the axial direction are provided on the outer surface of the axially extending portion 381 at equal intervals (intervals of 90°) in the circumferential direction (see FIG. 8). In addition, communication grooves 386 for communicating the radial vent grooves 384 to the outside in a state in which the plate member 7 is press-fitted to the press fitting protrusion 38 are provided on the outer surface of the bottom section 33 of the outer ring member 3 so as to be formed in circular recessed shapes. In addition, the cross section of each of the radial vent grooves 384, the axial vent grooves 385 and the communication grooves 386 is formed in a substantially circular arc shape. Then, the plate member 7 is press-fitted to the press fitting protrusion 38, and the radial vent grooves 384, the axial vent grooves 385 and the communication grooves 386 form the above-mentioned serial communication paths 74.

In addition, in the communication paths 74, the radial vent grooves 384 are connected to the respective axial vent grooves 385 via respective chamfered portions 387 formed by chamfering the outer peripheral edge (corner portion) of the distal end (rear end part) of the press fitting protrusion 38. In addition, in this way, the radial vent grooves 384 are connected to the respective axial vent grooves 385 via the respective chamfered portions 387, and thereby ventilation from the radial vent grooves 384 to the axial vent grooves 385 can be smoothly performed.

As mentioned above, according to the present embodiment, the communication paths are formed by covering the partitioning plate (plate member 7) onto the notch grooves (radial vent grooves 384, axial vent grooves 385 and communication grooves 386) provided to the outer ring member 3.

In this way, the communication paths are formed by the labyrinth-shaped communication paths instead of the hole 70, and as compared with the hole 70, the grease G inside the auxiliary chamber 30 further hardly leaks to the outside, and thereby the leakage of the grease G inside the auxiliary chamber 30 to the outside can be more effectively suppressed.

### Seventh Embodiment

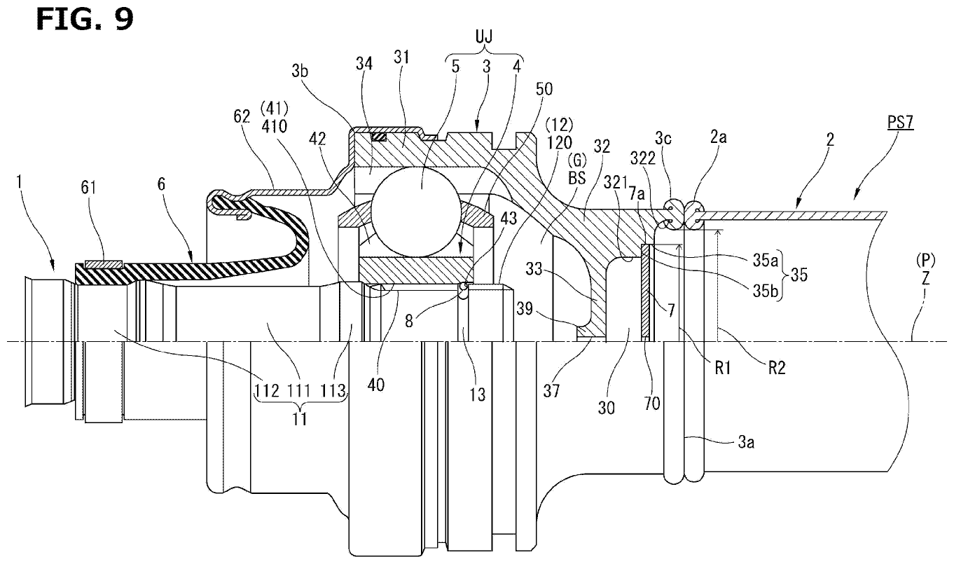

FIG. 9 shows a seventh embodiment of the propeller shaft according to the present invention, and in the seventh embodiment, the shape of the plate member 7 according to the fourth embodiment is changed. In addition, since a basic configuration of the seventh embodiment except the changed part is the same as that of the first embodiment, the same symbols are applied to the same components of the first embodiment, and redundant explanation is omitted.

FIG. 9 shows an enlarged sectional view of a main part of the propeller shaft according to the seventh embodiment of the present invention. In addition, in the following explanation, for convenience, in FIG. 9, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS7 according to the present embodiment, a vent hole protruding portion 39 protruding from the first end part 3a side toward the second end part 3b side of the outer ring member 3 in the axial direction is provided at the hole edge portion of the vent hole 37 that is the inner side surface of the bottom section 33 of the outer ring member 3 (surface facing the bearing accommodating space BS). In other words, the vent hole protruding portion 39 extending toward the bearing accommodating space BS side in the axial direction is formed on the outer peripheral side of the vent hole 37 of the bottom section 33 which faces the bearing accommodating space BS of the outer ring member 3, so as to protrude. The vent hole protruding portion 39 has a cylindrical shape, and is formed integrally with the bottom section 33 of the outer ring member 3, and the vent hole 37 is penetratingly formed on the inner peripheral side thereof.

As mentioned above, according to the present embodiment, in the direction of the rotation axial line Z, the vent hole 37 is provided with the vent hole protruding portion 39 protruding from the first end part 3a side toward the second end part 3b side of the outer ring member 3.

As mentioned above, since the grease G inside the bearing accommodating space BS is pushed to the peripheral wall of the bearing accommodating space BS by centrifugal force with the rotation of the propeller shaft PS7, the grease G hardly leaks to the auxiliary chamber 30 through the hole 37. In addition to this configuration, by further providing the vent hole protruding portion 39 protruding toward the bearing accommodating space BS side at the peripheral edge portion of the vent hole 37, the grease G inside the bearing accommodating space BS further hardly enters into the vent hole 37, and thereby the leakage of the grease G inside the bearing accommodating space BS to the outside can be more effectively suppressed.

### Eighth Embodiment

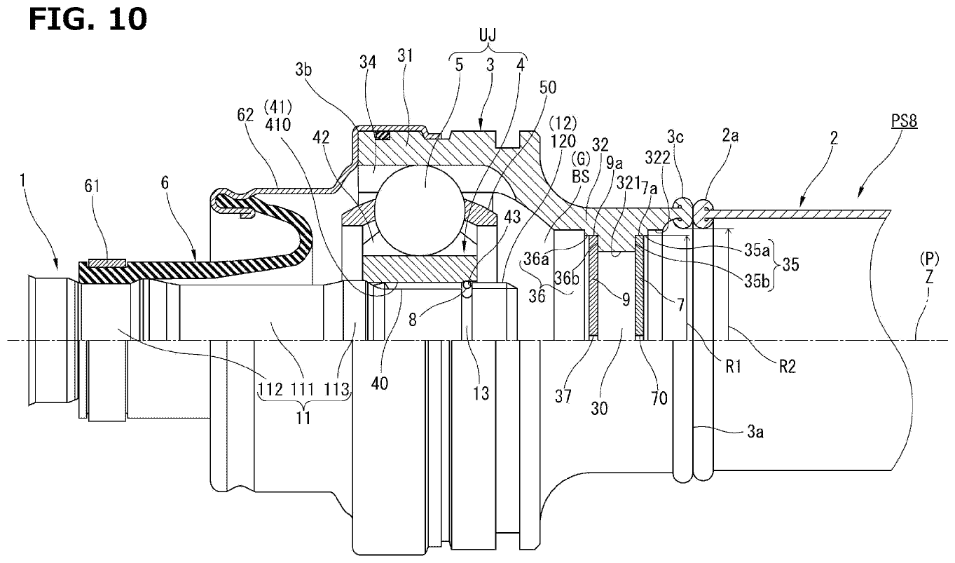

FIG. 10 shows an eighth embodiment of the propeller shaft according to the present invention, and in the eighth embodiment, the shape of the plate member 7 according to the fourth embodiment is changed. In addition, since a basic configuration of the eighth embodiment except the changed part is the same as that of the first embodiment, the same symbols are applied to the same components of the first embodiment, and redundant explanation is omitted.

FIG. 10 shows an enlarged sectional view of a main part of the propeller shaft according to the eighth embodiment of the present invention. In addition, in the following explanation, for convenience, in FIG. 10, the left side is referred to as “front”, and the right side is referred to as “rear”, and the direction along a rotation axial line (rotation center) Z is referred to as “axial direction”, the direction orthogonal to the rotation axial line Z is referred to as “radial direction”, and the direction around the rotation axial line Z is referred to as “circumferential direction”.

That is, in a propeller shaft PS8 according to the present embodiment, the bottom section 33 of the outer ring member 3 is formed by a bottom section constituting plate 9 that is a plate member separate from the outer ring member 3. Then, the auxiliary chamber 30 is formed between the bottom section constituting plate 9 and the plate member 7.

The bottom section constituting plate 9 is a metal disc plate having a substantially uniform thickness, similar to the plate member 7 according to the first embodiment, and includes, in the middle part thereof, a vent hole 37, and is attached to a second groove part 36 facing the bearing accommodating space BS in the connection base section 32 of the outer ring member 3. In addition, the bottom section constituting plate 9 has an outer diameter slightly larger than the inner diameter of the second groove part 36, and an outer peripheral surface 9a of the bottom section constituting plate 9 is press-fitted to an inner peripheral surface 36a of the second groove part 36 so as to be attached in a state of coming in contact with a second step part 36b formed between the second groove part 36 and the small diameter section 321.

In addition, the attaching means (fixing means) for the bottom section constituting plate 9 is not limited to the above-mentioned press fitting, and caulking shown in the variation of the first embodiment may be used.

As mentioned above, according to the present embodiment, the bottom section 33 is formed by a plate member (bottom section constituting plate 9) provided to the outer ring member 3 which is a member separate from the outer ring member 3.

In this way, since the bottom section of the outer ring member 3 is formed by the bottom section constituting plate 9 that is a member separate from the outer ring member 3, as compared with case where the bottom section is formed integrally with the outer ring member 3, the thickness (width in the axial direction) of the bottom section can be small (thin). Consequently, a reduction in the weight of the constant velocity universal joint UJ and a reduction in the weight of the propeller shaft PS8 can be achieved, and thereby the fuel consumption of the vehicle can be improved.

The present invention is not limited to the configurations and modes shown in the embodiments, and can be freely modified according to the specification and the cost of an object to be applied, as long as being a mode with which the above-mentioned working effects of the present invention can be obtained. In addition, the configurations of the embodiments can be combined with each other (for example, a combination of the plate protruding portion 73 shown in the fifth embodiment and the vent hole protruding portion 39 show in the seventh embodiment).

In particular, the auxiliary chamber 30 is provided between the bottom section 33 of the outer ring member 3 which includes the vent hole 37 and the plate member 7 which includes the communication path (hole 70 or communication paths 74) communicated to the outside, and this is one of the technical features of the present invention. Therefore, for example, configurations not having a direct relationship with technical features of, for example, the drive shaft 1, driven shaft 2 and the constant velocity universal joint UJ can be freely modified.

In addition, in each of the embodiments, as an example, although a mode has been shown in which the inner ring member 4 is arranged on the drive shaft 1 side and the outer ring member 3 is arranged on the driven shaft 2 side, the opposite configuration may be applied. That is, the present invention can also be applied to a mode in which, similar to the conventional propeller shaft, the outer ring member 3 is arranged on the drive shaft 1 side and the inner ring member 4 is arranged on the driven shaft 2 side.

In addition, in each of the embodiments, as an example, although a mode has been shown in which the outer ring member 3 of the constant velocity universal joint UJ is connected to the above-mentioned differential device which is not shown via the driven shaft 2, the present invention is not limited to this mode. That is, the present invention can also be applied to a mode in which, similar to the conventional propeller shaft, the outer ring member 3 of the constant velocity universal joint UJ is directly connected to the output shaft of the above-mentioned transmission device which is not shown or the input shaft of the above-mentioned differential device which is not shown.

In addition, in the fifth embodiment, as an example, although a configuration has been shown in which the plate protruding portion 73 is provided to the hole edge of the hole 70 in the plate member 7, the plate protruding portion 73 is applied to not only the plate member 7 formed in a substantially U shape opened on the front end side which is formed based on the fourth embodiment. In other words, the plate protruding portion 73 can be applied to any mode, including a mode in which the plate member 7 is formed in an entirely flat plate shape as shown in the first and second embodiments.

In addition, in the seventh embodiment, as an example, although a configuration has been shown in which the vent hole protruding portion 39 is provided to the hole edge of the vent hole 37 of the outer ring member 3, the present invention is not limited to the configuration. That is, the vent hole protruding portion 39 can be applied not only to a mode in which the position of the bottom section 33 of the outer ring member 3 and the position of the plate member 7 are reversed in the axial direction as shown in the second embodiment, but also to the bottom section (bottom section constituting plate 9) formed separately from the outer ring member 3 as shown in the eighth embodiment.

As a propeller shaft based on each of the embodiments explained above, for example, the following aspects can be considered.

That is, the propeller shaft, in one aspect thereof, includes: a cylindrical shaft member; a cylindrical outer ring member having a first end part connected to the shaft member, and including, in order from a second end part on an opposite side of the first end part in a direction of a rotation axial line of the shaft member, a raceway groove provided on an inner peripheral surface of the outer ring member and formed along the rotation axial line, a bottom section extending from an inner peripheral part of the outer ring member toward a rotation center of the shaft member, and a vent hole provided to the bottom section; a ball member which moves along the raceway groove; an inner ring member wherein the ball member is arranged on an outer periphery of the inner ring member; a rod member connected to the inner ring member, and extending from the first end part toward the second end part of the outer ring member in the direction of the rotation axial line; a boot member which covers between the second end part of the outer ring member and the rod member; a grease provided between the outer ring member and the inner ring member; a partitioning plate attached to the inner peripheral part of the outer ring member so as to form an auxiliary chamber between the bottom section and the partitioning plate; and a communication path which is either provided to the partitioning plate or formed by cooperation of the partitioning plate and the outer ring member to allow communication between a first end part side and a second end part side of the outer ring member with the partitioning plate interposed therebetween.

In a preferable aspect of the propeller shaft, the communication path is formed by a hole penetrating through the partitioning plate.

In another preferable aspect, in any of aspects of the propeller shaft, the partitioning plate is provided between the first end part and the bottom section of the outer ring member, in the direction of the rotation axial line.

In still another preferable aspect, in any of aspects of the propeller shaft, the hole is provided with a plate protruding portion protruding from the first end part side toward the second end part side of the outer ring member, in the direction of the rotation axial line.

In still another preferable aspect, in any of aspects of the propeller shaft, the vent hole is provided with a vent hole protruding portion protruding from the first end part side toward the second end part side of the outer ring member, in the direction of the rotation axial line.

In still another preferable aspect, in any of aspects of the propeller shaft, the hole is provided on the rotation center, in the direction of the rotation axial line.

In still another preferable aspect, in any of aspects of the propeller shaft, the vent hole is provided on the rotation center, in the direction of the rotation axial line.

In still another preferable aspect, in any of aspects of the propeller shaft, the partitioning plate is press-fitted into a groove part provided to the inner peripheral part of the outer ring member.

In still another preferable aspect, in any of aspects of the propeller shaft, the outer ring member includes a press fitting protrusion protruding from the bottom section so as to extend from the second end part side toward the first end part side of the outer ring member in the direction of the rotation axial line, the first end part of the outer ring member is joined to the shaft member by friction welding, an outer diameter of the press fitting protrusion is smaller than an inner diameter of a joint part between the first end part of the outer ring member and the shaft member, and the partitioning plate includes a partitioning plate press fitting portion capable of being press-fitted to an outer peripheral portion of the press fitting protrusion.

In still another preferable aspect, in any of aspects of the propeller shaft, the partitioning plate includes a partitioning plate bottom portion connected to the partitioning plate press fitting portion and extending toward the rotation center.

In still another preferable aspect, in any of aspects of the propeller shaft, the partitioning plate includes a partitioning plate bottom portion extending toward the rotation center and a partitioning plate press fitting portion capable of being press-fitted into the groove part, and extending from an outer peripheral edge portion of the partitioning plate bottom portion in the direction of the rotation axial line, and the partitioning plate is press-fitted into the groove part from a partitioning plate bottom portion side.

In still another preferable aspect, in any of aspects of the propeller shaft, the partitioning plate is fixed to a groove part provided to the inner peripheral part of the outer ring member by caulking.

In still another preferable aspect, in any of aspects of the propeller shaft, the bottom section is formed by a plate member provided to the outer ring member that is a member separate from the outer ring member.

In still another preferable aspect, in any of aspects of the propeller shaft, the partitioning plate is provided between the second end part and the bottom section of the outer ring member, in the direction of the rotation axial line.

In still another preferable aspect, in any of aspects of the propeller shaft, at least one of inner diameters of the hole and the vent hole gradually increases from the first end part side toward the second end part side of the outer ring member in the direction of the rotation axial line.

In still another preferable aspect, in any of aspects of the propeller shaft, the communication path is formed by covering the partitioning plate onto a notch groove provided to the outer ring member.

1. A propeller shaft comprising:
a cylindrical shaft member;
a cylindrical outer ring member having a first end part connected to the shaft member, and including, in order from a second end part on an opposite side of the first end part in a direction of a rotation axial line of the shaft member, a raceway groove provided on an inner peripheral surface of the outer ring member and formed along the rotation axial line, a bottom section extending from an inner peripheral part of the outer ring member toward a rotation center of the shaft member, and a vent hole provided to the bottom section;
a ball member which moves along the raceway groove;
an inner ring member wherein the ball member is arranged on an outer periphery of the inner ring member;
a rod member connected to the inner ring member, and extending from the first end part toward the second end part of the outer ring member in the direction of the rotation axial line;
a boot member which covers between the second end part of the outer ring member and the rod member;
a grease provided between the outer ring member and the inner ring member;
a partitioning plate attached to the inner peripheral part of the outer ring member so as to form an auxiliary chamber between the bottom section and the partitioning plate; and
a communication path which is either provided to the partitioning plate or formed by cooperation of the partitioning plate and the outer ring member to allow communication between a first end part side and a second end part side of the outer ring member with the partitioning plate interposed therebetween.

2. The propeller shaft according to claim 1, wherein the communication path is formed by a hole penetrating through the partitioning plate.

3. The propeller shaft according to claim 1, wherein the partitioning plate is provided between the first end part and the bottom section of the outer ring member, in the direction of the rotation axial line.

4. The propeller shaft according to claim 2, wherein the hole is provided with a plate protruding portion protruding from the first end part side toward the second end part side of the outer ring member, in the direction of the rotation axial line.

5. The propeller shaft according to claim 1, wherein the vent hole is provided with a vent hole protruding portion protruding from the first end part side toward the second end part side of the outer ring member, in the direction of the rotation axial line.

6. The propeller shaft according to claim 2, wherein the hole is provided on the rotation center, in the direction of the rotation axial line.

7. The propeller shaft according to claim 6, wherein the vent hole is provided on the rotation center, in the direction of the rotation axial line.

8. The propeller shaft according to claim 1, wherein the partitioning plate is press-fitted into a groove part provided to the inner peripheral part of the outer ring member.

9. The propeller shaft according to claim 1, wherein the outer ring member includes a press fitting protrusion protruding from the bottom section so as to extend from the second end part side toward the first end part side of the outer ring member in the direction of the rotation axial line,
wherein the first end part of the outer ring member is joined to the shaft member by friction welding,
wherein an outer diameter of the press fitting protrusion is smaller than an inner diameter of a joint part between the first end part of the outer ring member and the shaft member, and
wherein the partitioning plate includes a partitioning plate press fitting portion capable of being press-fitted to an outer peripheral portion of the press fitting protrusion.

10. The propeller shaft according to claim 9, wherein the partitioning plate includes a partitioning plate bottom portion connected to the partitioning plate press fitting portion and extending toward the rotation center.

11. The propeller shaft according to claim 8, wherein the partitioning plate includes a partitioning plate bottom portion extending toward the rotation center and a partitioning plate press fitting portion capable of being press-fitted into the groove part, and extending from an outer peripheral edge portion of the partitioning plate bottom portion in the direction of the rotation axial line, and
wherein the partitioning plate is press-fitted into the groove part from a partitioning plate bottom portion side.

12. The propeller shaft according to claim 1, wherein the partitioning plate is fixed to a groove part provided to the inner peripheral part of the outer ring member by caulking.

13. The propeller shaft according to claim 1, wherein the bottom section is formed by a plate member provided to the outer ring member that is a member separate from the outer ring member.

14. The propeller shaft according to claim 1, wherein the partitioning plate is provided between the second end part and the bottom section of the outer ring member, in the direction of the rotation axial line.

15. The propeller shaft according to claim 2, wherein at least one of inner diameters of the hole and the vent hole gradually increases from the first end part side toward the second end part side of the outer ring member in the direction of the rotation axial line.

16. The propeller shaft according to claim 1, wherein the communication path is formed by covering the partitioning plate onto a notch groove provided to the outer ring member.
